(19) United States
(12) Patent Application Publication
(10) Pub. No.: US 2006/0290353 A1
(43) Pub. Date: Dec. 28, 2006

(54) PAD ASSEMBLY FOR LOGGING TOOL

(75) Inventors: Mark A. Fredette, Houston, TX (US); Martin E. Poitzsch, Derry, NH (US)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 11/160,484

(22) Filed: Jun. 27, 2005

(51) Int. Cl. G01V 3/08; G01V 3/10; G01V 3/12

(52) U.S. Cl. 324/367

(57) ABSTRACT

An apparatus for logging a formation traversed by a borehole includes a tool adapted for conveyance inside the borehole, a tool bias mechanism comprising a flexible member coupled to a first side of the tool body and adapted to urge a second side of the tool body into contact with a side of the borehole, a sensing pad responsive to a property of the formation, and a pad bias mechanism independent of the tool bias mechanism coupling the sensing pad to the second side of the tool body and adapted to urge the sensing pad into contact with the side of the borehole.

### BACKGROUND OF THE INVENTION

The invention relates to apparatus for obtaining subsurface measurements. More specifically, the invention relates to logging tools that sense formation characteristics using a pad-type structure.

Formation evaluation logs contain data related to one or more properties of a formation as a function of depth. A formation evaluation log is typically recorded as a logging tool containing appropriate instrumentation traverses a borehole penetrating the formation. The logging tool may be conveyed inside the borehole in a number of ways, e.g., on cable, drill pipe, or coiled tubing. For operational efficiency, it is common to include a combination of logging tools in a single logging run. One example of a combination of logging tools is a triple-combo tool string, which measures formation density, porosity, deep and/or intermediate and/or shallow resistivity, natural gamma radiation, and borehole size in a single logging run.

Logging tools include sources and/or detectors which can emit or respond to various types of signals, including, for example, electrical, nuclear, or acoustic stimulus. The sources and/or detectors may be located in the tool body or on a sensing pad movably coupled to the tool body. In the latter case, it is desirable that the sensing pad maintain contact with the borehole wall even in the presence of irregularities. The pad assembly typically includes a mechanism for urging the sensing pad in contact with the borehole wall. Pad-based measurements are typically sensitive to standoff, i.e., distance between the pad face and the borehole wall. It is desirable that any mechanism that urges the sensing pad in contact with the borehole wall minimizes standoff under various operating conditions resulting from the varied geometrical shapes of borehole walls.

Typically, sensing pads are urged in contact with borehole walls using spring-loaded backup or caliper arms. For example, U.S. Pat. No. 4,594,552 (Grimaldi et al.) discloses a pad assembly including an arm at the end of which is mounted a sensing pad. The arm is pivotally connected to the tool body and has an integral extension on the end farthest from the sensing pad. The extension is resiliently connected to the tool body. A backup arm is pivotally connected to the extension and resiliently biased away from the tool body. In the extended position, the backup arm engages one side of the borehole wall while urging the sensing pad in contact with the opposite side of the borehole wall.

To avoid the backup arm becoming wedged in the borehole, the backup arm typically would have to be in the retracted position when the logging tool is run into the borehole or out of the borehole, depending on which direction the backup arm opens relative to the tool body. Measurements cannot be made effectively using the sensing pad when the backup arm is in the retracted position. However, it would be advantageous if measurements could be made effectively using the sensing pad, regardless of which direction the logging tool is running, i.e., into or out of the borehole. Therefore, a need remains for a more robust mechanism that would urge the pad in contact with the borehole wall regardless of which direction the logging tool is running.

### SUMMARY OF THE INVENTION

In one aspect, the invention relates to an apparatus for logging a formation traversed by a borehole which comprises a tool body adapted for conveyance inside the borehole, a tool bias mechanism comprising a flexible member coupled to a first side of the tool body and adapted to urge a second side of the tool body into contact with a side of the borehole, a sensing pad responsive to a property of the formation, and a pad bias mechanism independent of the tool bias mechanism coupling the sensing pad to the second side of the tool body and adapted to urge the sensing pad into contact with the side of the borehole.

In another aspect, the invention relates to a tool string for logging a formation traversed by a borehole which comprises a plurality of logging tools adapted for conveyance inside the borehole. The plurality of logging tools comprises a tool body, a tool bias mechanism comprising a flexible member coupled to a first side of the tool body and adapted to urge a second side of the tool body into contact with a side of the borehole, a sensing pad responsive to a property of the formation, and a pad bias mechanism independent of the tool bias mechanism coupling the sensing pad to the second side of the tool body and adapted to urge the sensing pad into contact with the side of the borehole.

In yet another aspect, the invention relates to a method of measuring a property of a formation traversed by a borehole which comprises disposing in the borehole a tool body carrying a sensing pad responsive to a property of the formation. The method further includes moving the tool body in the borehole, wherein as the tool body is moved in the borehole a tool bias mechanism comprising a flexible member urges a side of the tool body adjacent to the sensing pad in contact with a side of the borehole and a pad bias mechanism independent of the tool bias mechanism urges the sensing pad in contact with the side of the borehole. The method further includes measuring a formation property through the sensing pad.

Other features and advantages of the invention will be apparent from the following description and the appended claims.

### BRIEF DESCRIPTION OF DRAWINGS

FIG. 1A shows a logging tool incorporating a pad assembly according to one embodiment of the invention.

FIG. 1B shows the sensing pad of FIG. 1A in a retracted position.

FIGS. 2A-2C show a tool string including the logging tool of FIGS. 1A and 1B.

### DETAILED DESCRIPTION OF THE INVENTION

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to avoid unnecessarily obscuring the invention.

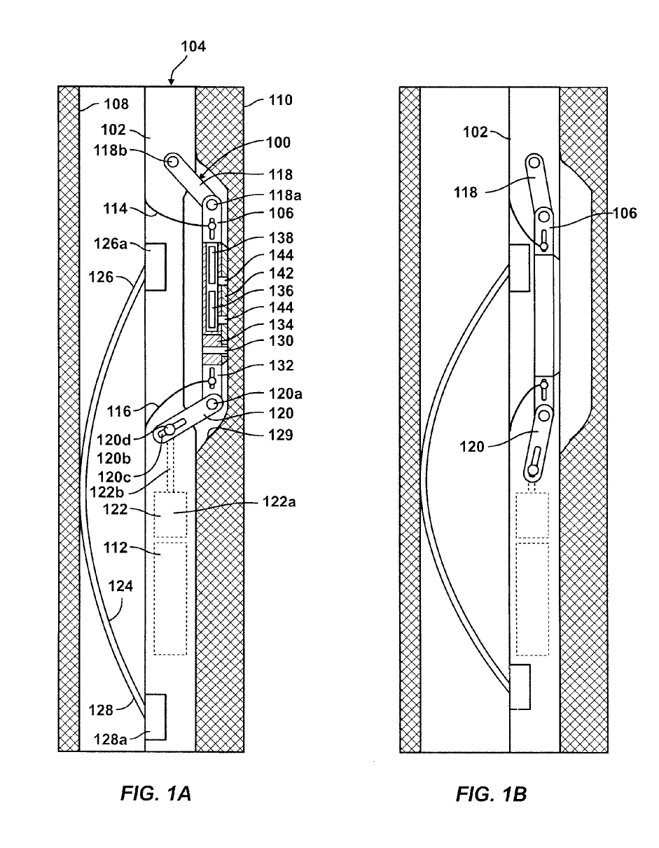

FIG. 1A shows a pad assembly 100 according to one embodiment of the invention. The pad assembly 100 is coupled to a body 102 of a logging tool 104. The pad assembly includes a sensing pad 106, which carries one or more detectors that respond to acoustic, nuclear, or electrical stimuli. The pad 106 may also carry one or more sources that emit acoustic, nuclear, or electrical stimuli. The logging tool 104 may be lowered into a borehole 108 traversing formation 110 to allow measurements of the borehole/formation through the sensing pad 106. The logging tool 104 may be conveyed inside the borehole 108 in a number of ways, including, but not limited to, on the end of a wireline, slickline, coiled tubing, or drill pipe. To make borehole/formation measurements, the sensing pad 106 contacts the borehole 108 surface. An electronics cartridge 112, which may be located inside or external to the tool body 102, cooperates with the sensing pad 106 to make measurements. The electronics cartridge 112 includes appropriate circuitry to power the detector(s) on the sensing pad 106 and to process and transmit signals. The measurement data may be sent to the surface in real-time or stored in a memory tool and retrieved when the logging tool 104 is pulled to the surface.

The pad assembly 100 includes a pad bias mechanism for urging the sensing pad 106 in contact with a side of the borehole 108. In one embodiment, the pad bias mechanism includes springs 114, 116, such as leaf springs, coupled between the tool body 102 and the sensing pad 106. The pad bias mechanism further includes linkages 118, 120 coupled between the tool body 102 and the pad 106. The linkages 118, 120 allow the position of the sensing pad 106 relative to the tool body 102 to be adjustable. While the springs 114, 116 urge the sensing pad 106 away from the tool body 102, the linkages 118, 120 limit how far the sensing pad 106 can move away from the tool body 102. Linkage 118 is coupled to the sensing pad 106 and tool body 102 by joints 118a, 118b, respectively. Linkage 120 is coupled to the sensing pad 106 and tool body 102 by joints 120a, 120b, respectively. The joints 118a, 118b, 120a, 120b could be implemented in any number of ways. In one embodiment, the joints 118a, 118b are pivot or hinge joints, which may be provided by mating pins and holes or other suitable structures. In one embodiment, the joints 120a, 120b are pivot or hinge joints, which may be provided by mating pins and holes or other suitable structures.

In one embodiment, at least one of the joints 118b and 120b is also capable of sliding relative to the tool body 102. This provides flexibility in positioning the sensing pad 106 relative to the tool body 102. For example, it may be desirable to move the sensing pad 106 between a retracted position, wherein the sensing pad 106 is flush or nearly flush with the tool body 102 (FIG. 1B), and a deployed position, wherein the sensing pad 106 can make contact with irregularities in a side of the borehole 108. In one embodiment, the joint 120b includes a slot 120c that mates with a pin 120d coupled to the tool body 102. Thus, the linkage 120 may slide relative to the tool body 102 by simply allowing the pin 120d to ride in the slot 120c as the tool body 102 traverses the borehole 108.

It may be desirable to control sliding of the linkage 120 relative to the tool body 102. In one embodiment, sliding of the linkage 120 is controlled through the use of an actuator 122 located within the tool body 102. The actuator 122 could include a motor 122a which drives an actuator rod 122b, such as a lead screw. In this example, the pin 120d is coupled to the actuator rod 122b. The motor 122a may then be operated as needed to extend or retract the actuator rod 122b, thereby moving the pin 120d inside the slot 120c, thereby causing the linkage 120 to slide relative to the tool body 102. In another embodiment, sliding of the linkage 120 is controlled through the use of a one-shot release system (not shown), such as a one-shot electrical latch, e.g., a solenoid and hook linkage. In this case, the linkage 120 is latched to the tool body 102 using the one-shot release system. The one-shot release system prevents sliding of the linkage 120 until a desired time when the one-shot release system is activated or released.

The pad bias mechanism has been described with respect to springs 114, 116 biasing the sensing pad 110 away from the tool body 102. In an alternate embodiment, the springs 114, 116 may be omitted and a coil spring may be used to bias the sensing pad 110 away from the tool body 102. In the current embodiment shown in FIG. 1A, the coil spring (not shown) could replace the motor 122a. The coil spring would be coupled between the actuator rod 122b and the tool body 102. Initially, the coil spring can be latched to the tool body 102 using, for example, a one-shot electrical latch. This would also serve to prevent sliding of the linkage 120. At a desired time, the one-shot electrical latch can be activated or released. This would then allow the coil spring to extend the actuator rod 122b. The actuator rod 122b is coupled to the linkage 120. Thus, extension of the actuator rod 122b would serve to bias the sensing pad 110 away from the tool body 102. In this case, it is not necessary that the linkage 120 have the slot 120c, and a simple pin and hole connection between the linkage 120 and the actuator rod 122b would suffice.

To minimize surface wear of the sensing pad 106, particularly if the sensing pad 106 is run into the borehole 108 in a deployed position, easily replaceable wear buttons, plates, or housings may be used to protect the sensing pad 106. These surface wear protectors would be long-wearing parts and provide a minimal standoff so that the measurement quality is not affected and may incorporate a time-to-replace-me indicator.

The pad assembly 100 includes a tool bias mechanism for urging the side of the tool body 102 adjacent to the sensing pad 106 in contact with a side of the borehole 108. The tool bias mechanism includes a flexible member 124, such as a bow spring, located opposite the sensing pad 106. The ends 126, 128 of the bow spring 124 are coupled to the tool body 102 by joints 126a, 128a, respectively. The joints 126a, 128a can be implemented in any number of ways. In one embodiment, the joints 126a, 128a allow pivoting and sliding of the bow spring ends 126, 128 relative to the tool body 102. In one embodiment, the joint 126a includes mating pin and hole, and the joint 128a includes mating pin and slot. The mating pin and hole at joint 126a allow pivoting of the bow spring end 126 relative to the tool body 102. The mating pin and slot at joint 128a allow pivoting and sliding of the bow spring end 128 relative to the tool body 102. Thus, the bow spring 124 can expand and contract as the tool body 102 traverses the borehole 108.

When the bow spring 124 engages one side of the borehole 108, it presses the tool body 102 against the opposite side of the borehole 108. A wall-engaging pad (not shown) may be attached to the middle portion of the bow spring 124 as the tool body 102 traverses the borehole 108. The motion of the bow spring 124 may be monitored and translated into borehole caliper measurement. The force of the bow spring 124 is designed to hold the entire tool body 102 against a side of the borehole 108. The force of the springs 114, 116 is designed to maintain the sensing pad 106 in contact with the formation 110 even in the presence of local irregularities, such as depression 129 shown in a side of the borehole 108.

The logging tool 104 may be configured to make any number of measurements. For example, the logging tool 104 may measure formation density, for example, using a conventional dual-detector gamma-gamma measurement configuration. This includes a gamma ray source 130 mounted in the body 132 of the sensing pad 106. The gamma ray source 130 is surrounded by a shield 134 made of a high density shielding material, such as tungsten. Gamma ray detectors 136, 138 are also mounted in the body 132 of the sensing pad 106. The detectors 136, 138 are longitudinally aligned with the source 130. The detector 136 closest to the source 130 is known as the short-spaced detector, and the detector 138 farthest from the source 130 is known as the long-spaced detector. Intermediate and backscattering detectors may also be provided in the pad body 132 as taught in, for example, U.S. Pat. No. 5,390,115 (Case et al.) and U.S. Pat. No. 5,528,029 (Chapellat et al.), respectively. A shield 142 made of a high density shielding material, such as tungsten, is mounted on the pad body 132. The source 130 and detectors 136, 138 communicate with the formation 110 through windows 144, made of material transparent to gamma rays, such as epoxy resin, in the shield 142.

The logging tool 104 configured as described above measures formation density in a conventional manner. To measure formation density, the logging tool 104 is lowered to a desired depth in the borehole 108. Also, the sensing pad 106 is pressed against a side of the borehole 108 using the mechanism previously described. As the logging tool 104 ascends the borehole 108, the source 130 emits gamma radiation and the detectors 136, 138 detect gamma returning particles and generate output pulses in response. The energies of the detected gamma particles are representative of specific interaction phenomena between the gamma particles emitted by the source 130 and the atoms in the formation. The output pulses are received by the electronics cartridge 112, which counts the output pulses for a predetermined time period at appropriate time intervals and converts the total count for each detector 136, 138 to a count rate. The count rate is then expressed for each detector 136, 138 as a function of the energy of each gamma particle. A calibration process is used to determine formation density from the count rates of each detector 136, 138.

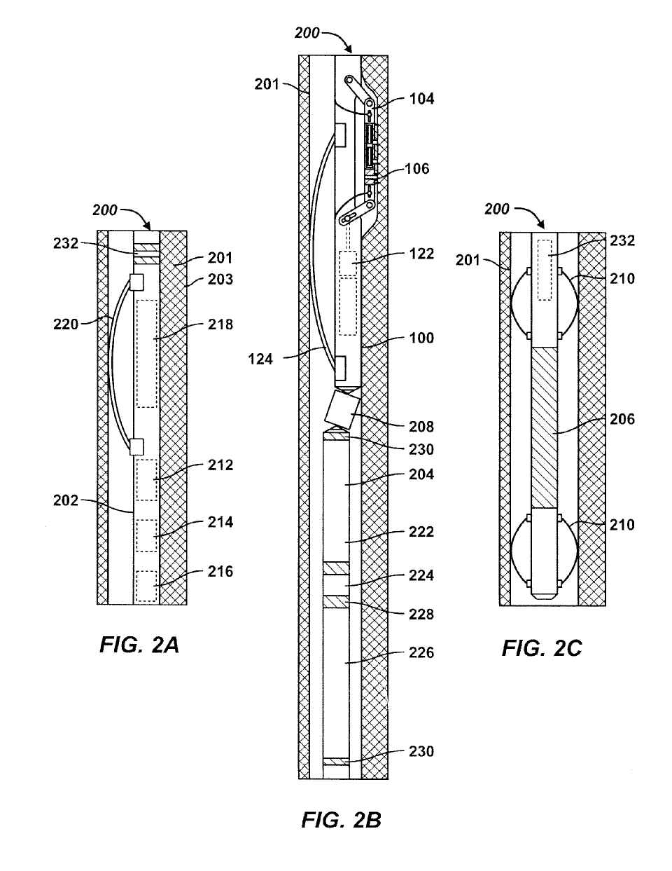

FIGS. 2A-2C together form a complete assembly of a triple-combo tool string 200 according to an embodiment of the invention. The tool string 200 is disposed in a borehole 201 traversing a formation 203. The tool string 200 includes logging tools 202 (FIG. 2A), 104 (FIG. 2B), 204 (FIG. 2B), and 206 (FIG. 2C). A hinge joint 208 (FIG. 2B) is provided between the logging tools 104, 204. The hinge joint 208 allows the logging tools 204, 206 attached below the logging tool 104 to be centered in the borehole 201 even when the logging tool 104 is not centered within the borehole 201. Centralizers 210 (FIG. 2C) are provided on the logging tool 206 to position the logging tool 206 in the center of the borehole 201. Centralizers may also be provided on the logging tool 204 (FIG. 2B) as needed. In one embodiment, the logging tool 202 (FIG. 2A) measures porosity, the logging tool 104 (FIG. 2B) measures density, as described above, the logging tool 204 (FIG. 2B) makes a lateral measurement of resistivity, and the logging tool 206 (FIG. 2D) makes an induction-based measurement of resistivity. The logging tool 204 (FIG. 2B) employs parts of the tool string 200 above and below it in making its measurements. The tool string 200 may be run into the borehole 201 with the sensing pad 106 (FIG. 2B) of the logging tool 104 deployed or retracted.

In one example, the logging tool 202 (FIG. 2A) includes a neutron source 212 and dual detectors 214, 216 to provide a compensated porosity measurement. The neutron tool 202 also includes a telemetry cartridge 218 for sending measurement data to the surface. An upper bow spring 220 is attached to the neutron tool 202. The upper bow spring 220 engages a side of the borehole 201 while urging the neutron tool 202 towards the opposite side of the borehole 201. The upper bow spring 220 may be configured for borehole caliper measurement. The upper bow spring 220 and lower bow spring 124 (FIG. 2B) co-operate to hold the connected bodies of the tool string 200 against a side of the borehole 201. A single bow spring may be used instead of two bow springs 220, 124 if the single bow spring is positioned properly to avoid creating a moment that would tend to misalign the logging tool 200 in the borehole 201.

The lateral formation resistivity logging tool 204 (FIG. 2B) includes current emitting bucking electrodes 222 and 226 and current emitting measure electrode 224. The measure electrode 224 is separated from the bucking electrodes 222 and 226 by insulating material 228. The downward-going current returns on the metal body of the logging tool 206 (FIG. 2C), and the upward-going current returns on the metal bode of the hinge joint 208 (FIG. 2B) and metal body of the logging tool 104 (FIG. 2B). The returns are separated from the bucking electrodes 222, 226 by mass isolation (or insulating) bands 230. An isolated electrode 232 at the top of the neutron tool 202 (FIG. 2A) provides a distant reference voltage for the lateral resistivity measurement. In this example, the logging tool 206 (FIG. 2C) may be an induction formation resistivity tool. The logging tool 206 may incorporate a natural gamma ray detector 234.

Advantages of the present invention include a pad assembly entailing a mechanism for urging a pad against a side of the borehole so that measurements can be made through the pad. The mechanism has two parts. The first part of the mechanism includes a flexible member such as a bow spring which urges the body of the logging tool, to which the pad is coupled, against a side of the borehole. The flexible member engages a side of the borehole and collapses as necessary as the logging tool traverses the borehole. The flexible member does not have the tendency to become wedged in the borehole regardless of the direction in which the logging tool is running inside the borehole. Therefore, measurements can be made with the pad regardless of the direction in which the logging tool is moving in the borehole. The second part of the mechanism urges the pad against irregularities such as depressions in a side of the borehole, thereby minimizing standoff between the pad and the formation. The pad assembly allows the logging tool to move up or down inside the borehole without retracting the sensing pad. The pad assembly makes the logging tool less complex and less costly than conventional pad-based logging tools. Reduced complexity allows the logging tool to be smaller, and smaller tools can be operated by fewer people at the well site.

While the invention has been described with respect to a limited number of embodiments, those skilled in the art, having benefit of this disclosure, will appreciate that other embodiments can be devised which do not depart from the scope of the invention as disclosed herein. It will also be appreciated that conventional components, connectors, electronics, and materials can be used to implement embodiments of the invention. The components (e.g. linkages, hinges, springs) used to implement embodiments of the invention may be formed of non-metallic materials or insulated materials.

What is claimed is:

1. An apparatus for logging a formation traversed by a borehole, comprising:
a tool body adapted for conveyance inside the borehole;
a tool bias mechanism comprising a flexible member coupled to a first side of the tool body and adapted to urge a second side of the tool body into contact with a side of the borehole;
a sensing pad responsive to a property of the formation; and
a pad bias mechanism independent of the tool bias mechanism coupling the sensing pad to the second side of the tool body and adapted to urge the sensing pad into contact with the side of the borehole.

2. The apparatus of claim 1, wherein the flexible member is a bow spring having ends movably coupled to the first side of the tool body.

3. The apparatus of claim 1, wherein the pad bias mechanism comprises a first linkage and a second linkage coupling the sensing pad to the tool body.

4. The apparatus of claim 3, wherein the linkages are pivotally coupled to the sensing pad and the tool body.

5. The apparatus of claim 4, wherein the first linkage is slidably coupled to the tool body.

6. The apparatus of claim 5, further comprising an actuator mounted in the tool body for sliding the first linkage relative to the tool body.

7. The apparatus of claim 1, wherein the sensing pad is movable between a retracted position where the pad is substantially flush with the second side of the tool body and a deployed position where the sensing pad is urged into contact with the side of the borehole.

8. The apparatus of claim 3, wherein the pad bias mechanism further comprises a spring coupled between the sensing pad and the tool body, the spring having a force selected to urge the sensing pad in contact with the side of the borehole.

9. The apparatus of claim 1, wherein the sensing pad carries a nuclear radiation source and a nuclear radiation detector.

10. The apparatus of claim 1, wherein the sensing pad is responsive to density of the formation.

11. A tool string for logging a formation traversed by a borehole, comprising:
a plurality of logging tools adapted for conveyance inside the borehole, the plurality of logging tools comprising:
a tool body;
a tool bias mechanism comprising a flexible member coupled to a first side of the tool body and adapted to urge a second side of the tool body into contact with a side of the borehole;
a sensing pad responsive to a property of the formation; and
a pad bias mechanism independent of the tool bias mechanism coupling the sensing pad to the second side of the tool body and adapted to urge the sensing pad into contact with the side of the borehole.

12. The tool string of claim 11, wherein the flexible member comprises a bow spring having ends movably coupled to the first side of the tool body.

13. The tool string of claim 11, wherein the pad bias mechanism comprises a first linkage and a second linkage coupling the sensing pad to the tool body.

14. The tool string of claim 13, wherein the linkages are pivotally coupled to the sensing pad and the tool body and the first linkage is slidably coupled to the tool body.

15. The tool string of claim 13, further comprising an actuator mounted in the tool body for sliding the first linkage relative to the tool body.

16. The tool string of claim 13, further comprising a spring coupled between the sensing pad and the tool body, the spring having a force selected to urge the sensing pad in contact with the side of the borehole.

17. The tool string of claim 11, wherein the plurality of logging tools comprises a tool selected from the group consisting of a neutron tool, a lateral formation resistivity tool, an induction formation resistivity tool, and a gamma ray tool.

18. The tool string of claim 11, wherein the sensing pad is responsive to density of the formation.

19. A method of measuring a property of a formation traversed by a borehole, comprising:
disposing in the borehole a tool body carrying a sensing pad responsive to a property of the formation;
moving the tool body in the borehole, wherein as the tool body is moved in the borehole a tool bias mechanism comprising a flexible member urges a side of the tool body adjacent to the sensing pad in contact with a side of the borehole and a pad bias mechanism independent of the tool bias mechanism urges the sensing pad in contact with the side of the borehole; and
measuring a formation property through the sensing pad.
